(19) United States
(12) Patent Application Publication
(10) Pub. No.: US 2008/0233658 A1
(43) Pub. Date: Sep. 25, 2008

(54) Environmental Fluorescent Sensors

(75) Inventors: Mary Cecelia Massey MARSHALL, San Antonio, TX (US); Jonathan Scott SCHULZE, San Antonio, TX (US); Ralph Henry HILL, San Antonio, TX (US)

Correspondence Address: GROSSMAN, TUCKER, PERREAULT & PFLEGER, PLLC, 55 SOUTH COMMERICAL STREET, MANCHESTER, NH, 03101, US

(73) Assignee: SOUTHWEST RESEARCH INSTITUTE, San Antonio, TX (US)

(21) Appl. No.: 11/689,601

(22) Filed: Mar. 22, 2007

(51) Int. Cl. G01N 21/64

(52) U.S. Cl. 436/172; 422/52

(57) ABSTRACT

The present disclosure relates to a fluorescence marker such as quantum dots and their use as sensors which may rely upon a change in fluorescence output upon exposure to a given environmental condition. The variation in fluorescence output may then be utilized as an indication of exposure to a given environmental condition.

### FIELD OF INVENTION

The present disclosure relates to a fluorescence marker such as quantum dots and their use as sensors which may rely upon a change in fluorescence output upon exposure to a given environmental condition. The markers may then be employed to determine exposure of an object to a particular environment.

### BACKGROUND

Quantum dots (QD) are nanometer-scale particles of metal, dielectric or semiconductor material. Quantum dots may therefore provide useful optical properties when incorporated into various matrix materials such as polymeric resins. Quantum dots as semiconductors may also confine the motion of conduction band electrons, valence band holes or excitons (pairs of conduction band electrons and valence band holes) in all three spatial directions. Quantum dots may also provide luminescent properties at various specific wavelengths.

### SUMMARY

One aspect of this disclosure relates to a device or method for determining exposure of an object to a given environment. The device may utilize a fluorescent marker, such as quantum dots (QD). The fluorescent marker may be one that is capable of a change in fluorescence output due to exposure to a given environmental condition, which may include exposure to a gas, liquid, solid and/or electromagnetic energy. An object may then be associated with the fluorescent marker wherein the change in fluorescence output may be associated with the object's exposure. The fluorescence output may include, upon exposure to a given illumination source, a change in fluorescence intensity and/or a change in fluorescence versus time.

### BRIEF DESCRIPTION OF THE DRAWINGS

The detailed description below may be better understood with reference to the accompanying figures which are provided for illustrative purposes and are not to be considered as limiting any aspect of the invention.

FIG. 1A is an exemplary graph of fluorescence intensity versus wavelength (λ).

FIG. 1B is an exemplary graph of fluorescence intensity versus time for quantum dots illustrating the change in QD fluorescence due to exposure to a particular environmental condition.

FIG. 2 is an exemplary diagram for an electroluminescent device utilizing quantum dots.

FIG. 3 identifies the fluorescence from a Sony Handycam in “nightshot” mode for PbS quantum dots prior to exposure to indicated environmental conditions.

FIG. 4 identifies the fluorescence from a Sony Handycam in “nightshot” mode for PbS quantum dots subsequent to exposure to indicated environmental conditions

FIG. 5 indicates the average relative intensity (arbitrary units) of the red component from 210 pixels over the indicated time period, utilizing Adobe Photoshop, for PbS quantum dots exposed to air (no light) and to air (light-UV).

FIG. 6 illustrates an exemplary circuit diagram for an electroluminescent device utilizing quantum dots.

FIG. 7 is a flow chart illustrating the use of a fluorescent marker and its ability to identify environmental exposure.

### DETAILED DESCRIPTION

The present disclosure relates to fluorescent sensors. Such sensors may then be employed to identify exposure duration and/or intensity to a given environmental condition (solid, liquid, gas and/or electromagnetic energy). This may therefore include exposure to a certain light source at a particular wavelength (λ) or range of wavelengths. It may also include exposure to a given intensity of light and/or exposure to a particular light source as a function of time. The fluorescent sensors may include quantum dots which may be associated with a given product, which fluorescence may change due to environmental exposure, which may then indicate product lifetime and/or the remaining capability of a particular product to function as intended.

Quantum dots (QD) may therefore be understood herein as particles that may have a diameter (largest cross-sectional dimension) in the range of about 1-1000 nanometers (nm), including all values and ranges therein. For example, the quantum dots herein may fall in the range of about 1-100 nm including all values and ranges therein. A quantum dot particle may also assume any particular geometry. For example, quantum dots herein may include spheres, rods, disks, pyramids, cubes, wires, etc.

The quantum dots may also comprise materials sourced from Group IV elements, including but not limited to Si, Ge, and C; Group II-VI materials including but not limited to ZnS, ZnSe, ZnTe, ZnO, CdS, CdSe, CdTe, CdO, HgS, HgSe, HgTe, HgO, MgS, MgSe, MgTe, MgO, CaS, CaSe, CaTe, CaO, SrS, SrSe, SrTe, SrO, BaS, BaSe, BaTe, and BaO; Group III-V materials including but not limited to AlN, AlP, AlAs, AlSb, GaN, GaP, GaAs, GaSb, InN, InP, InAs, and InSb; Group IV-VI materials including but not limited to PbS, PbSe, PbTe, and PbO; and mixtures thereof. The quantum dots may also be prepared by a variety of techniques, such as vapor deposition, ion-implantation, photolithography, spatially modulated electric fields, semiconductor doped glasses, strain-induced potential variations in quantum wells, atomic width fluctuations in quantum wells, and a number of other techniques. For example, quantum dots herein may be specifically prepared by means of a colloidal synthesis. This may be understood as a freestanding structure that may be dispersed in a solvent and which may then be purified. Colloidal quantum dots may also be incorporated into a matrix material. A matrix material may be understood as any material that may be selected due to desired chemical or physical properties which may be utilized in conjunction with the quantum dots for a desired application. The quantum dots herein may therefore be prepared from a single material and/or from a plurality of materials that may therefore assume a core-shell configuration. A shell may therefore include a layer of material, either organic or inorganic, and may either fully surround or partially surround the core.

The quantum dots may provide fluorescent light that may be present for a period of time after exposure to an excitation source. An electromagnetic excitation source may therefore be understood as any source that provides energy transmitted through space or matter in the form of electromagnetic waves. Such source may include an LED or a laser. A LED (light emitting diode) may be understood as a semiconductor diode that includes a p-n junction, which may emit narrow-spectrum light when electrically biased in the forward direction. The LED may provide an excitation generating electromagnetic energy in the range of 200 to 1500 nm, including all values and increments therein, such as 380 nm, 450 nm to 470 nm, etc. A laser (light amplification by stimulated emission of radiation) may be understood as an optical source that may emit photons in a coherent beam and may also have a relatively narrow-spectrum bandwidth. The laser may be a solid state laser, such as a doubled neodymium doped yttrium aluminum garnet (Nd:YAG) laser, which may produce a wavelength of approximately 532 nm, however, other laser sources may be contemplated as well such as gas lasers including helium-neon or argon-ion, or laser diodes. Lasers may provide an excitation generating electromagnetic energy in the range of about 150 to over 3,000 nm, including all values and increments therein, such as 532 nm, 193-351 nm, etc. However, other optical sources, or excitation sources may be utilized herein.

The electromagnetic energy may be emitted from the excitation source and may therefore be in the form of waves at a given wavelength (λ). The electromagnetic energy may be illuminated onto the quantum dots and lead to luminescence wherein the molecular absorption of photons by the quantum dots may trigger the emission of another photon that may be at longer or different wavelengths having varying degrees of intensity. Luminescence may generally refer to and include both fluorescent and phosphorescent effects. Fluorescence may be understood as relatively fast luminescence, exhibiting decay on the order of nanoseconds to microseconds (e.g. the half-life decay of the fluorescent light may be about 25-30 nanoseconds or less). Phosphorescence may be understood as luminescence exhibiting a relatively longer emission of the electromagnetic energy.

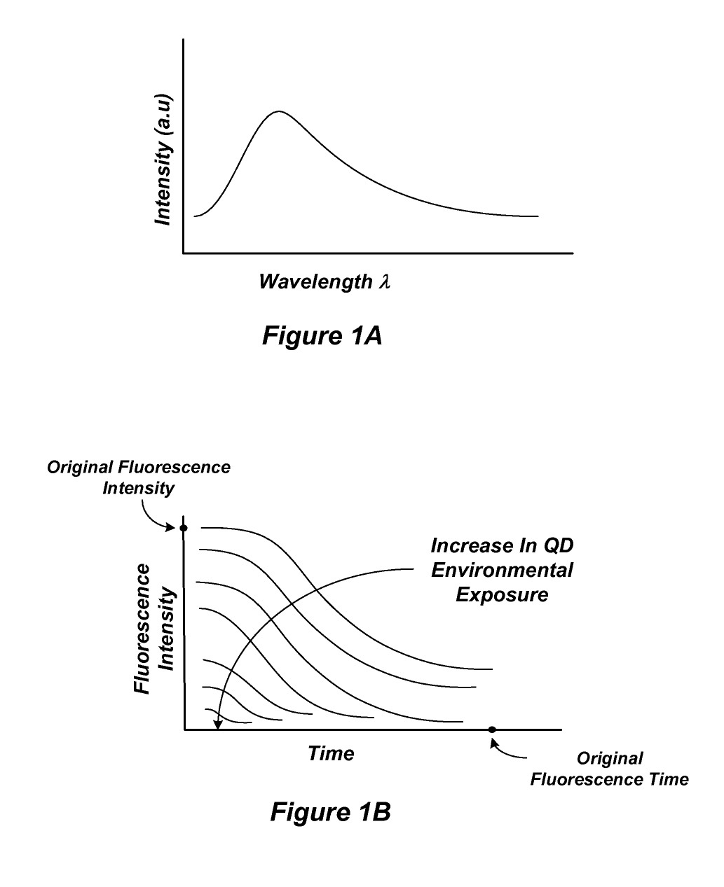

The fluorescence may have a relatively unique spectrum for the quantum dots depending upon the excitation source wavelength. Such spectrum may therefore amount to a plot of fluorescence intensity (arbitrary units) versus wavelength. FIG. 1A. The ability of the quantum dots to provide fluorescence has now been observed to be influenced by exposure to a given environmental condition. As noted above, this may be exposure for a given duration (time) and/or intensity (e.g., energy level). As therefore illustrated in FIG. 1B, the fluorescence of quantum dots has been observed to vary such that upon an increase in, e.g., the time and/or intensity of exposure to a given light source (e.g. U.V. light), substantially all fluorescing capability of the quantum dots may degrade. For example, as illustrated, this may be understood as a loss of greater than or equal to about 90% of the original fluorescence intensity and/or a loss of greater than or equal to about 90% of the time in which the quantum dots may fluoresce after exposure to a given excitation source.

The synthetic preparation of the quantum dots may also influence fluorescence capability. More specifically, the synthesis of quantum dots may produce different materials which now may be relied upon to provide varying responses to a given environmental condition. Attention is therefore directed to the preparation of colloidal PbS nanocrystals that may provide size tunable near infrared (NIR) emissions, M. A. Hines, G. D. Scholes, Adv. Mater. 2003, 15, 1844, whose teachings are incorporated herein by reference. Near infrared emissions may therefore be understood herein as 0.70-2.5 μm in wavelength.

PbS quantum dots suitable for use herein were therefore prepared from lead oxide (PbO) and oleic acid (OA) to form lead oleate. Lead oleate was then combined with a reactive sulfur compound such as hexamethyldisilathiane (HMDS) to form PbS particles. The relatively long chain fatty acid (OA) may therefore influence the size of the PbS particles, which were found in this exemplary synthesis to be about 5-10 nanometers in diameter. The PbS dots may then be precipitated into methanol, re-dissolved in toluene, precipitated into acetone, dried, and re-dissolved in toluene for characterization purposes. The reaction conditions (e.g. reaction temperature, reaction composition such as ratio of OA to Pb, or reaction time) may therefore be varied during synthesis which may then influence the absorption and fluorescence of the quantum dots, as illustrated in Table 1.

TABLE 1
PbS Synthesis - Reaction Conditions & Fluorescence Characteristics

| | | OA:Pb | | Wavelength | Wavelength |
|---|---|---|---|---|---|
| Experi- | Reaction | Molar | Reaction | of Peak | of Peak |
| ment | Temp (° C.) | Ratio | Time | Absorbance | Fluorescence |
| 1 | 30 | 4:2 | 10 min | 640 nm | |
| 2 | 30 | 4:2 | 10 min | 630 nm | |
| 3 | 80 | 4:2 | 10 min | 680 nm | 829 nm |
| 4 | 140 | 4:2 | 10 min | 865 nm | 917 nm |
| 5 | 80 | 32:2 | 10 min | 1056 nm | |
| 6 | 80 | 16:2 | 10 min | 1011 nm | |
| 7 | 80 | 4:2 | 60 min | 700 nm | 840 nm |
| 8 | 140 | 4:2 | 10 min | 964 nm | 982 nm |
| 9 | 80 | 64:2 | 10 min | 1182 nm | 1241 nm |
| 10 | 140 | 64:2 | 10 min | 1603 nm | 1592 nm |
| 11 | 120 | 64:2 | 10 min | 1381 nm | 1421 nm |
| 12 | 100 | 64:2 | 10 min | 1447 nm | 1487 nm |

Accordingly, it can be seen that the wavelength of peak absorbance may be varied between about 600 nanometers to about 1500 nanometers as the size of the PbS quantum dots increase, which as noted may be attributed to the particular reaction conditions. For example, at a constant OA:Pb ratio, increasing reaction temperature generally increases wavelength at peak absorbance (compare experiments 1-4). In addition, increasing the OA:Pb ratio also increases wavelength at peak absorbance, and high molar ratios of OA:Pb and high reaction temperature provide PbS quantum dots that absorb and fluoresce over 1400 nm (see experiments 10-12).

As alluded to above, the synthesized quantum dots herein may be incorporated into a matrix material, which may be any host material in which the quantum dots may be dispersed and where the matrix material may serve as a continuous phase. Accordingly, the matrix material may include a polymeric material, and in particular, a thermoplastic polymer resin which may be dissolved in a selected solvent. Such polymers may therefore be specifically selected from one or more resins from the group of acrylate polymers which may have the following general formula:

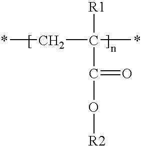

wherein R1 is a hydrogen, alkyl or aromatic group, and R2 is an alkyl group or aromatic group. The matrix material may also include polycarbonates, polyesters, cellulosic resins, etc. Such polymers may therefore include generally amorphous polymers which may transmit greater than about 90% visible light. By way of example, the quantum dots prepared in Table 1, Experiment No. 7, were combined with poly(methyl methacrylate) and mixed in toluene and cast onto glass and wood substrates. In addition, such quantum dots were also cast directly onto a glass substrate in the absence of any PMMA. The samples were then evaluated with using green laser excitation in combination with an Ocean Optics high resolution spectrometer.

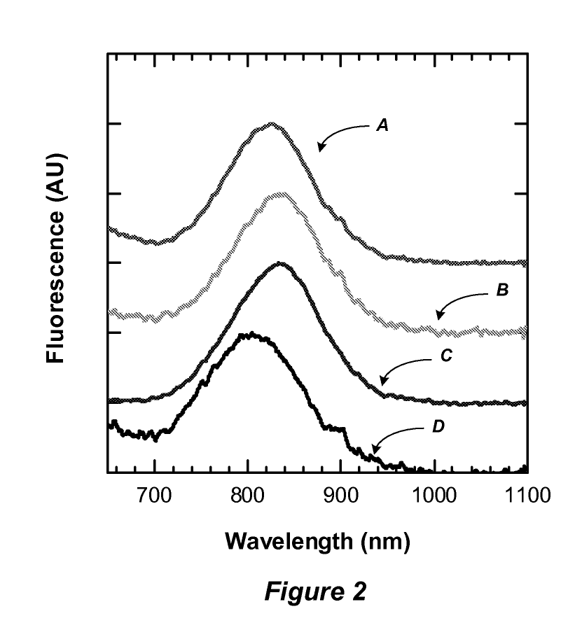

FIG. 2 illustrates the fluorescence for the quantum dots from Experiment 7 in Table 1, in the indicated matrix polymer and substrate: A: PMMA on wood; B: PMMA on glass. Fluorescence plot “C” indicates no matrix material while “D” represents EVIDOT® lead sulfide quantum dots in PMMA on glass. EVIDOT® quantum dots are commercially available from Evident Technologies Inc., Troy, N.Y.

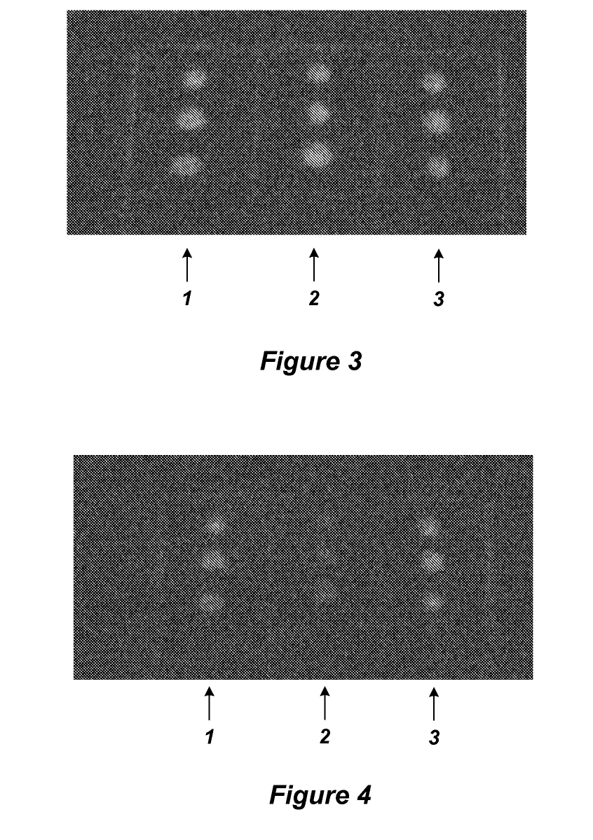

Environmental testing proceeded as follows. PbS quantum dots were combined with PMMA and toluene and cast as three separate films on glass slides. Slide “1” was placed in near dark conditions in a humidity chamber at 30° C. at a relative humidity of about 72%. Slide “2” was allowed to remain under standard laboratory fluorescent lighting, and slide “3” was wrapped in foil and placed in darkness. Once a day, the glass slides were photographed via use of a Sony Handycam under UV excitation (about 400 nm) from a UV LED flashlight source. FIG. 3 therefore indicates the fluorescence (as viewed from the Sony Handycam in “nightshot” mode) on day 1 and FIG. 4 indicates the fluorescence 10 days later.

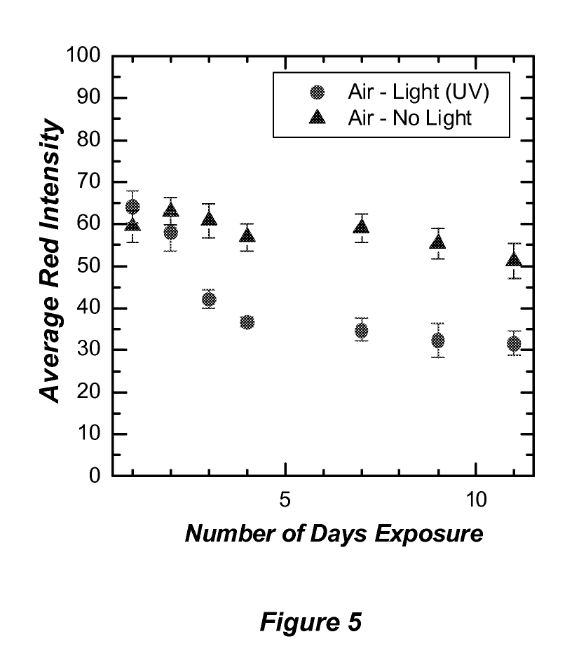

The images were then analyzed using an image analysis and processing program (Adobe Photoshop). The intensity of the red component of 210 pixels from the portion of the image corresponding to each film on the glass slides was recorded, for a total of three intensities per slide. The three intensity data points were then averaged and plotted as a function of average red intensity (arbitrary units) versus time, as shown in FIG. 5. The error bars represent one standard deviation. It can therefore be observed that the fluorescence of the quantum dots on the glass slides exposed to light (particularly UV light) would degrade, whereas the fluorescence of the quantum dots maintained in darkness remained relatively constant. See again, FIG. 4. It is contemplated herein that the fluorescence output of the quantum dots may therefore be due to light exposure and/or the matrix material (PMMA) may respond to electromagnetic energy such that it may reduce the QD fluorescence output, as noted herein.

As may now be appreciated, a quantum dot sensor herein may include one or more different quantum dots that each may provide a unique change in fluorescence output to a given environmental condition or may confirm data from another quantum dot to increase the accuracy and precision of the detector. For example, the sensor may include one set of quantum dots that may provide a change in fluorescence output in response to a first wavelength (λ₁), such as UV light (100-400 nm). The sensor may then include a second set of quantum dots that may provide a change in fluorescent output to a second wavelength (λ₂), such as X-rays (0.01-10 nm). Accordingly, when such combinations of quantum dots are therefore associated with a given object, it may then indicate the time and/or intensity of exposure of the object to one or more sources of electromagnetic radiation. By intensity of exposure it may be understood, in the case of electromagnetic energy, as the energy (E) of the photons associated with such electromagnetic radiation, i.e. E=hc/λ. (where h is defined as Planck's constant, c is the speed of light, and λ is the wavelength of light.) With respect to other environmental conditions, the intensity of exposure may relate to, e.g., the concentration of a given chemical reagent.

For example, the fluorescent marker herein may include a first fluorescent marker (FM₁) and a second fluorescent marker (FM₂), where each may be sourced from a particular type of quantum dot, where each may provide a change in fluorescent output upon exposure. For example, the first fluorescent marker may therefore have a peak fluorescence intensity at a first wavelength (λ₁) and the second fluorescent marker may have a peak fluorescence intensity at a second wavelength (λ₂), wherein λ₁≠λ₂. Such peak fluorescence intensity may also be one that changes subsequent to exposure to such wavelengths. In such manner, the system may then provide an indication of exposure to either or both of λ₁ or λ₂.

Accordingly, the present disclosure also contemplates that the number of different fluorescent markers that may be employed may be adjusted to that number of markers suitable to identify a given number of environmental conditions. For example, one may select a first fluorescent marker that indicates a change in fluorescence output due to exposure to electromagnetic energy, a second fluorescent marker that may indicate a change in fluorescent output upon exposure to a gas (e.g. oxygen thereby triggering oxidation of the quantum dots or matrix material), and a third fluorescent marker that may indicate a change in fluorescent output upon exposure to a liquid (e.g. water). Therefore, it may now be appreciated that in the context of the present disclosure a given object may be associated with, e.g. 1-10 fluorescent markers, including all values and increments therein.

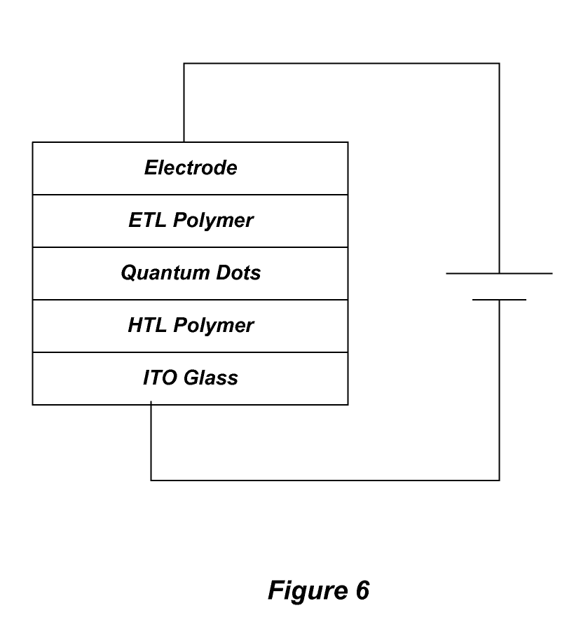

The fluorescent markers herein which may utilize an electromagnetic excitation source as noted above, may also use electrical input to provide for fluorescence. Attention is directed to FIG. 6 which illustrates one circuit configuration contemplated herein for an electrical electroluminescent device. As can be seen, the excitation source may include an electrode, an electron transport layer (ETL), quantum dots, a hole transport layer (HTL) and an indium tin oxide (ITO) glass layer. The purpose of the HTL may be to maximize hole injection from the anode (ITO/glass). The HTL may be sourced from triarylamine-based materials. As may therefore be appreciated, the quantum dots may be positioned between two conducting polymer layers. A voltage may then be applied which may pass a current through the quantum dots. The quantum dots may then fluoresce for as long as current may be present. However, upon loss of fluorescence, as contemplated herein, the device may short-circuit, current may no longer pass and the device will no longer fluoresce. As may now be appreciated, by embedding the quantum dots into a known excitation source, one may provide a visual “go/no-go” or “use/do not use” indication for a given object which has been exposed to a given environment.

In view of all of the above, it may now be recognized that numerous applications are contemplated by the present disclosure that may rely upon a fluorescent marker, such as a quantum dot, to monitor and detect an environmental condition. By way of example, applications may be directed at consumer products, security and/or shelf-life monitoring. More specifically, photographic film, sunscreen, plant grow lights, computer data storage devices, radiation badges, etc., may all be associated with a given fluorescent marker, and depending upon the fluorescent marker's change in fluorescence due to a given condition (e.g. exposure to electromagnetic radiation) the fluorescent marker may provide an indication of time and/or intensity of exposure of such products to such environment.

For example, with regards to the specific use of a fluorescent marker with sunscreen (e.g. compositions that may contain a UV absorber such as p-aminobenzoic acid, cinnamates, salicylates, benzene compounds, etc.) it may be appreciated that a substrate (flexible polymeric film) may be configured to include quantum dots, wherein the quantum dots, upon exposure to sunlight, may alter (e.g. decay) in fluorescence output. This flexible film may, for example, be decoratively attached to the bathing suit receiving similar sunlight and water exposure as the bare skin. This may then be associated with a given control chart (which may also be included in the substrate film) which may then signal to the user when additional sunscreen may be required. Accordingly, it is contemplated herein that the fluorescent markers may be associated with a calibration device, which may be understood as any device that may provide a user with an indication of the time of exposure to a given environmental condition (e.g. time of exposure to electromagnetic energy) and/or the intensity of exposure (e.g. particular wavelength of electromagnetic energy).

With regards to the exemplary use of a plant grow light, which may be understood as a light that provides electromagnetic energy suitable to promote photosynthesis or plant growth, it may be appreciated that one may apply a fluorescent marker herein at the plant (growth) location. Depending upon the light output, and fluorescent marker response, the user may be informed as to the optimal distance for optimal light intensity and/or the decay in plant grow light efficiency over time. With regards to the use of computer storage devices, the fluorescent marker herein may be incorporated into, e.g., a flash drive, and may capture and monitor incidental electromagnetic energy exposure. A user may then periodically inspect the marker and be informed as to whether or not data storage systems may be on the threshold of compromising data thereby triggering timely back-up operations. With regards to foods, medicines and/or chemicals, such products may also be associated with the fluorescent markers herein to provide, e.g., an indication of “expiration” due to environmental exposure and breakdown of chemical or pharmaceutical activity.

It is also contemplated herein that the fluorescent marker may be associated with a device for detection of fluorescence. Accordingly, the detection instrumentation may include one or more devices for detecting the various wavelengths or forms electromagnetic energy, such as a photodetector. Photodetectors may include photodiodes or charge coupled devices. A photodiode may be understood as a semiconductor including a p-n junction. When electromagnetic energy of a given wavelength range strikes the photodiode, photons may be absorbed resulting in the production of a photocurrent. The photodiode may be silicon based and may be sensitive to wavelengths in the range of 190 to 1100 nm, including all values and increments therein. A charge coupled device (CCD) may be understood as an image sensor including an integrated circuit containing an array of linked or coupled capacitors or photodiodes sensitive to electromagnetic energy. CCD's may also be sensitive to wavelengths in the range of 150 to 1100 nm, including all values and increments therein.

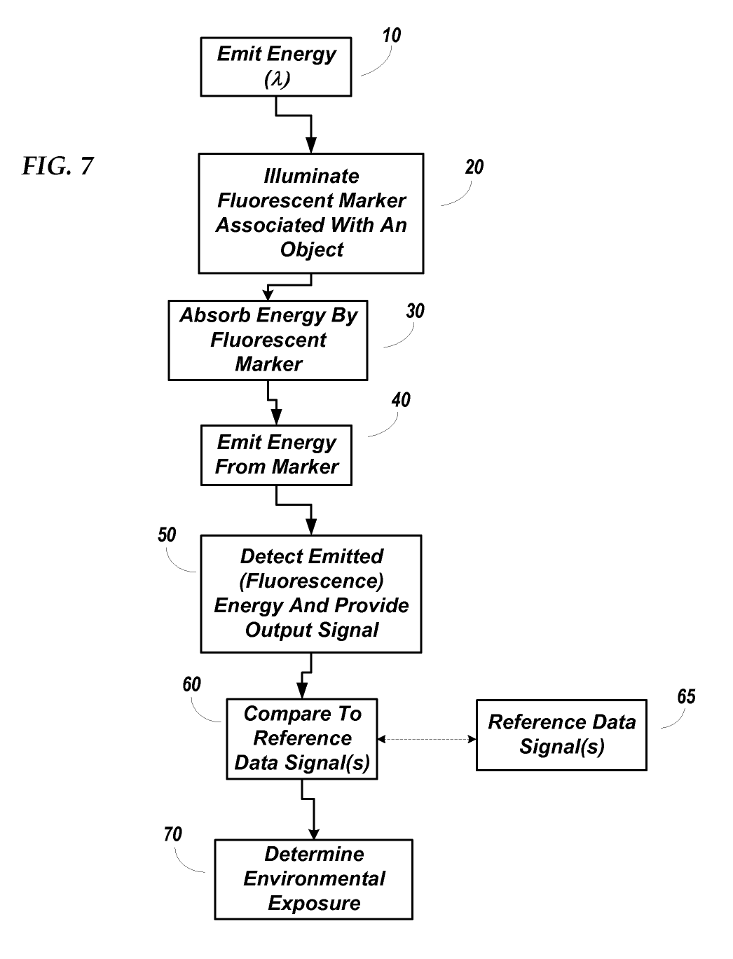

In addition, it is contemplated herein that the fluorescent marker and its ability to identify environmental exposure may be illustrated in flow-chart form as shown in FIG. 7. Electromagnetic energy may be emitted from excitation source 10. The excitation energy may be in the form of waves at a given wavelength (λ) or range of wavelengths. The electromagnetic energy may be illuminated onto the fluorescent marker 20 that may have been associated with a given object and exposed to a given environment. It may therefore be understood that reference to associating with a given object may be understood in two ways, one as being placed in the same environment as the object so that the fluorescent marker may experience substantially the same environmental conditions. The fluorescent marker may therefore be affixed to the object, or it may be separate, depending upon a particular object's design requirements. Second, the matrix selected for embedding the marker may provide a controlled release and/or event sequencing to initially protect a marker. For example, a water-soluble, electromagnetic radiation blocking material (e.g. film) covering could be placed on the marker to prevent degradation until the film is dissolved by water, thereby measuring the environmental exposure after a triggering event (in this example, water contact). Accordingly, the blocking material may be selected such that it may protect the fluorescent marker from exposure to a given environmental condition for a selected period of time, wherein the protection provided by the material may itself be a function the time and/or intensity of environmental exposure.

The fluorescent marker may then absorb the electromagnetic energy at 30 followed by emission of energy at 40, which may therefore include some amount of fluorescence. See again, FIG. 1A or 1B. The fluorescence may then be detected at step 50 by the above referenced devices suitable for fluorescence detection which may then compare at step 60, via the use of a suitable processor, the detected fluorescence output to a referenced fluorescence output 65. The referenced fluorescence output may therefore amount to previously collected data regarding a change in fluorescence output over time for a given environmental condition. Upon comparison to the referenced fluorescence output, an indication may be provided at 70 regarding the given object's exposure.

The foregoing description is provided to illustrate and explain the present invention. However, the description hereinabove should not be considered to limit the scope of the invention set forth in the claims appended here to.

What is claimed is:

1. A device for determining exposure of an object to an environmental condition comprising:
a fluorescent marker that is capable of a change in fluorescence output upon exposure to an environmental condition; and
an object associated with said fluorescent marker wherein said change in fluorescence output is capable of being associated with said object's exposure to said environmental condition.

2. The device of claim 1 wherein said fluorescent marker comprises particles having a diameter of about 1-1000 nanometers.

3. The device of claim 2 wherein said particle is selected from the group consisting of PbS, PbSe, PbTe, PbO or mixtures thereof.

4. The device of claim 1 wherein said change in fluorescence output comprises a change in fluorescence intensity upon exposure to electromagnetic energy.

5. The device of claim 1 wherein said change in fluorescence output comprises a change in fluorescence intensity versus time upon exposure to electromagnetic energy.

6. The device of claim 1 wherein said fluorescent marker comprises a first fluorescent marker (FM₁) and a second fluorescent marker (FM₂), wherein FM₁ has a peak fluorescence intensity at a first wavelength (λ₁) and FM₂ has a peak fluorescence intensity at a second wavelength (λ₂), wherein λ₁≠λ₂.

7. The device of claim 1 wherein said fluorescent marker provides fluorescence at wavelengths of about 0.70-2.5 μm.

8. The device of claim 1 including an excitation source capable of providing fluorescence in said fluorescent marker.

9. The device of claim 8 wherein said excitation source comprises a light emitting diode, a laser, or electrical input.

10. The device of claim 1 including a matrix material wherein said fluorescent marker is dispersed in said matrix material.

11. The device of claim 10 wherein said matrix material comprises an acrylic polymer of the following structure: 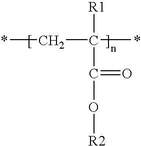
wherein R1 is a hydrogen, alkyl or aromatic group, and R2 is an alkyl group or aromatic group.

12. The device of claim 1 including a detection device for detection of fluorescence.

13. The device of claim 1 wherein exposure to said environmental condition comprises exposure to one or more of a solid, liquid, gas or electromagnetic energy.

14. The device of claim 1 wherein said change in fluorescent output is capable of being associated with said object's time of exposure to said environmental condition.

15. The device of claim 1 wherein said change in fluorescent output is capable of being associated with the intensity of exposure of said object to said environmental condition.

16. A device for determining exposure of an object to an environmental condition comprising:
a fluorescent marker comprising particles having a diameter of about 1-1000 nanometers that is capable of a change in fluorescence output upon exposure to electromagnetic energy; and
an object associated with said fluorescent marker wherein said change in fluorescence output is capable of being associated with said object's exposure to said electromagnetic energy.

17. The device of claim 16 wherein said particle is selected from the group consisting of PbS, PbSe, PbTe, PbO or mixtures thereof.

18. The device of claim 16 wherein said fluorescent marker provides fluorescence at wavelengths of about 0.70-2.5 μm.

19. A device for determining exposure of an object to an environmental condition comprising:
a first fluorescent marker that is capable of a change in fluorescence output upon exposure to a first environmental condition;
a second fluorescent marker that is capable of a change in fluorescence output upon exposure to a second environmental condition;
an object associated with said first and second fluorescent markers wherein said change in fluorescence output is capable of being associated with said object's exposure to said first and second environmental condition.

20. The device of claim 19 wherein said first environmental condition comprises electromagnetic energy and said second environmental condition comprises one of a gas, liquid or solid.

21. A method for determining exposure of an object to an environment condition comprising:
associating a fluorescent marker with an object wherein said marker is capable of a change in fluorescence output upon exposure to an environmental condition;
exposing said fluorescent marker to said environmental condition;
determining one of:
(a) the time of exposure to said environmental condition; or
(b) the intensity of said environmental condition.

22. The method of claim 21 wherein said fluorescent marker comprises particles having a diameter of about 1-1000 nanometers.
